(19) United States
(12) Patent Application Publication
(10) Pub. No.: US 2007/0257133 A1
(43) Pub. Date: Nov. 8, 2007

(54) Nozzle Device For Cleaning A Window

(76) Inventors: Jens Bettenhausen, Rotenburg a.d. Fulda (DE); Gerhard Vogt, Bebra (DE)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 11/576,079

(22) PCT Filed: Aug. 31, 2005
(86) PCT No.: PCT/EP05/54280

§ 371 Date: Mar. 27, 2007

(30) Foreign Application Priority Data
Sep. 27, 2004 (DE) 10 2004 046 781.1

(51) Int. Cl. B60S 1/52

(52) U.S. Cl. 239/284.1

(57) ABSTRACT

A nozzle device (3) for cleaning a window (2) has a plurality of nozzle openings (15, 16). One nozzle opening (15) which is embodied as a localised jet nozzle is arranged on the end of a groove-type recess (18) of the nozzle body (6). The nozzle body (6) is pressed into a nozzle housing (4) guiding a washing liquid. In this way, the nozzle opening (15) is formed partially by the nozzle body (6) and partially by the nozzle housing (4). The nozzle device (3) is thus especially cost-effective.

### CROSS-REFERENCE TO RELATED APPLICATIONS

This application is a U.S. national stage application of International Application No. PCT/EP2005/054280 filed Aug. 31, 2005, which designates the United States of America, and claims priority to German application number DE 10 2004 046 781.1 filed Sep. 27, 2004, the contents of which are hereby incorporated by reference in their entirety.

### TECHNICAL FIELD

The invention relates to a nozzle device for cleaning a window, in particular a windshield or a diffusion lens of a headlamp of a vehicle, with at least two nozzle openings for discharging a respective jet of washing liquid, wherein the nozzle openings have different radiating characteristics and wherein at least one of the nozzle openings is designed as a localized jet nozzle.

### BACKGROUND

A nozzle device of this type is frequently used in motor vehicles nowadays and is known from practice. A fan-shaped jet is usually sprayed here onto the window through one of the nozzle openings and uniformly wets the window. By contrast, the localized jet nozzle sprays a hard jet with a small spraying area in comparison to the other nozzle opening onto a designated region of the window. A wiper distributes the washing liquid. In the known nozzle device, the nozzle openings are each produced by inserts which are fixed in a passage guiding washing liquid in the nozzle housing. The insert provided for the localized jet nozzle is generally a spherical nozzle.

A drawback of the known nozzle device is that a dedicated insert for each localized jet nozzle has to be fixed in the nozzle housing. Furthermore, the insert of the localized jet nozzle may be displaced and may therefore deviate from designated spraying areas of the window. This is particularly annoying in particular in the case of nozzle devices having two nozzle openings, since both spraying regions have to be coordinated with each other.

### SUMMARY

A nozzle device of the type mentioned above can be designed in such a manner that it permits precise alignment of a localized jet nozzle with a further nozzle opening, and that the nozzle device can be produced particularly cost-effectively.

A nozzle housing having a central passage for guiding washing liquid may have a receptacle for the precisely fitting and nonrotatable insertion of a nozzle body, wherein a recess is guided from the central passage as far as the nozzle openings and is sealed off on its longest extent in the nozzle body or the nozzle housing from the respectively opposite component, and wherein the nozzle opening designed as a localized jet nozzle is formed partially by the wall of the nozzle body and partially by the wall of the nozzle housing.

### BRIEF DESCRIPTION OF THE DRAWINGS

The invention permits numerous embodiments. To further clarify its basic principle, one of them is illustrated in the drawing and is described below. In the drawing

FIG. 1 shows, diagrammatically, a sectional illustration through a nozzle device according to an embodiment with adjacent components of a vehicle,

FIG. 2 shows, in enlarged form, a perspective illustration of a nozzle body of the nozzle device according to the embodiment from FIG. 1,

FIG. 3 shows, perspectively, an oblique sectional illustration through the nozzle body from FIG. 2.

### DETAILED DESCRIPTION

According to the embodiments described here, the localized jet nozzle is no longer formed by a separate insert, but rather the nozzle opening of the localized jet nozzle is designed as a subregion of an individual nozzle body and is therefore reliably aligned with the other nozzle opening. The other nozzle opening may be, for example, a fan nozzle. Since the alignment of the nozzle opening of the localized jet nozzle with the other nozzle opening is defined by the shaping of the nozzle body and of the nozzle housing, a displacement of the alignment of the localized jet nozzle is reliably avoided. Since the nozzle device according to an embodiment requires only two components for a plurality of nozzle openings with the nozzle housing and the nozzle body, it can be produced particularly cost-effectively.

According to another embodiment, the production and alignment of a plurality of nozzle openings designed as localized jet nozzles require a particularly low structural outlay if a plurality of groove-type recesses extend on one side of the nozzle body from the central passage as far as a plurality of nozzle openings.

The nonrotatable mounting of the nozzle body in the nozzle housing requires, according to another embodiment, a particularly low structural outlay if the nozzle body has a noncircular cross section.

Components which are additionally to be fitted, for sealing off the nozzle body from the nozzle housing, can be avoided in a simple manner, according to another embodiment, if the nozzle body is manufactured integrally with sealing lips for sealing it off from the receptacle of the nozzle housing.

The installation of the nozzle device according to an embodiment requires a particularly low outlay if the nozzle body is pressed into the nozzle housing.

The nozzle body could be held in the nozzle housing, for example, exclusively in a frictional manner. Since, however, nozzle devices are exposed to high temperature fluctuations and have to have a long service life, an exclusively frictional fixing may result in leakages or in the nozzle body falling out of the nozzle housing. The nozzle device has, according to another embodiment, a particularly long service life if the nozzle body and/or the nozzle housing have/has a recess and the respectively opposite component has an elastically resilient projection penetrating the recess. The spring-elastic projection may be produced, for example, by a simple deformation of the sufficiently deformable material, preferably of the nozzle housing. After the nozzle body is pressed into the receptacle of the nozzle housing, the projection engages behind the recess and holds the nozzle body.

According to another embodiment, the fixing of the nozzle body in the nozzle housing is simplified if the recess is designed as a groove and the projection as a bead.

The nozzle device according to an embodiment is capable of producing a plurality of spraying regions reliably aligned in relation to one another if at least one localized jet nozzle is arranged on one end side of the nozzle body and a fluidic nozzle, flat jet nozzle or fan jet nozzle is arranged on the other end side.

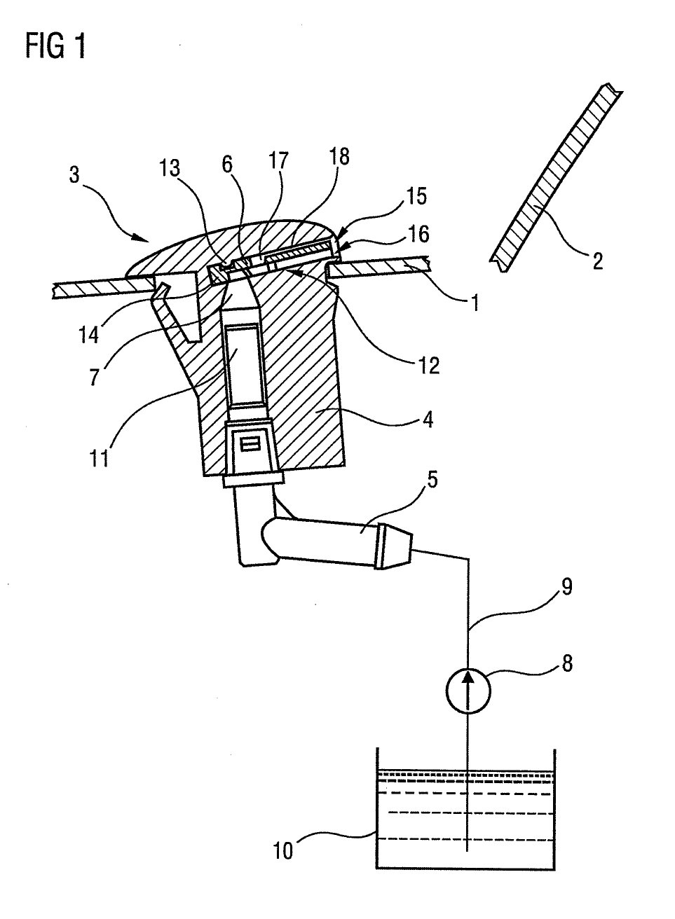

FIG. 1 shows a nozzle device 3 fixed in a panel 1 of a vehicle in front of a window 2. Of course, the nozzle device 3 may also be fixed in another component arranged in front of the window 2, such as, for example, a water box, ventilation grille, fender or the like. The nozzle device 3 has a nozzle housing 4 with a central passage 7 leading from a connecting branch 5 to a nozzle body 6. A washing liquid line 9 leading to a washing liquid pump 8 can be connected to the connecting branch 5. The washing liquid pump 8 conveys washing liquid from a washing liquid container 10 to the nozzle device 3. A nonreturn valve 11 is arranged in the central passage 7 and permits a flow of washing liquid exclusively in the direction from the washing liquid pump 8 to the nozzle body 6. Furthermore, the nozzle housing 4 can have a heating device (not illustrated) for heating the washing liquid.

The nozzle housing 4 has a receptacle 12 for the precisely fitting and nonrotatable insertion of the nozzle body 6. The nozzle body 6 is pressed into the receptacle 12 and is sealed off from the latter. The nozzle housing 4 has a projection 13 which is designed as a bead and penetrates a recess 14, designed as a groove, of the nozzle body 6.

The projection 13 is designed to be slightly resilient and produces an interlocking connection for mounting the nozzle body 6.

The nozzle device 3 has a plurality of nozzle openings 15, 16, with the lower of the nozzle openings 16 being designed as a fluidic nozzle with an oscillating, fan-shaped jet and the upper of the nozzle openings 15 being designed as a localized jet nozzle. Instead of the fluidic nozzle, use may also be made of a flat jet nozzle or fan jet nozzle which has a different radiating characteristic from the localized jet nozzle. A central passage 17 in the nozzle body 6 is connected to the central passage 7 in the nozzle housing 4 and distributes the conveyed washing liquid to the nozzle openings 15, 16. The nozzle opening 15 of the localized jet nozzle is connected via a groove-type recess 18 to the central passage 17 of the nozzle body 6 and is produced by the walls of the nozzle body 6 and the nozzle housing 4.

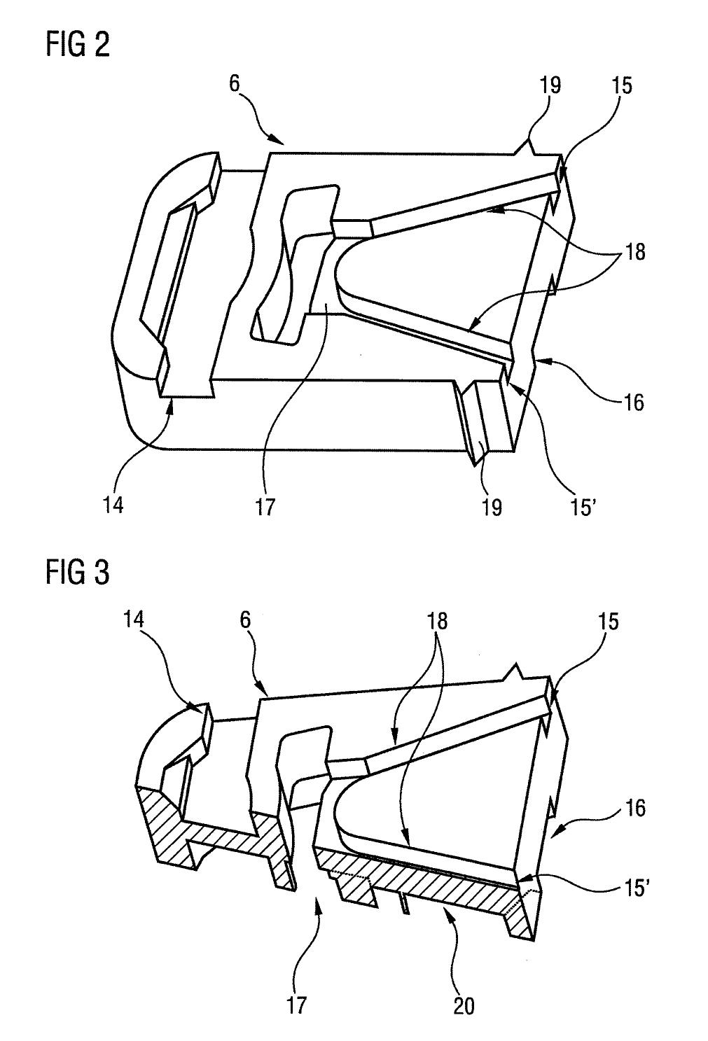

FIG. 2 shows, in a perspective illustration of the nozzle body 6, that a total of two groove-type recesses 18 are arranged in the nozzle body 6. In the fitted state, the groove-type recesses 18 are sealed off by the wall of the nozzle housing 4 on the upper side of the nozzle body 6 and are guided to a total of two nozzle openings 15, 15′. Furthermore, the nozzle body 6 is manufactured integrally with sealing lips 19 which, in the fitted state, seal off the nozzle body 6 in the receptacle 12 of the nozzle body 4 illustrated in FIG. 1.

FIG. 3 shows, in a sectional illustration through the nozzle body 6 from FIG. 2, that the nozzle body 6 has, upstream of the lower nozzle opening 16, a recess 20 for producing an oscillating nozzle opening 16 which sprays in a fan-shaped manner. The recess 20 is likewise connected to the nozzle opening 16 and the central passage 17 of the nozzle body 6.

What is claimed is:

1. A nozzle device for cleaning a window with at least two nozzle openings for discharging a respective jet of washing liquid, wherein the nozzle openings have different radiating characteristics and wherein at least one of the nozzle openings is designed as a localized jet nozzle, wherein a nozzle housing having a central passage for guiding washing liquid has a receptacle for a precisely fitting and nonrotatable insertion of a nozzle body and a recess is guided from the central passage as far as the nozzle openings and is sealed off on its longest extent in the nozzle body or the nozzle housing from a respectively opposite component, and wherein the nozzle opening designed as a localized jet nozzle is formed partially by a wall of the nozzle body and partially by a wall of the nozzle housing.

2. The nozzle device according to claim 1, wherein a plurality of groove-type recesses extend on one side of the nozzle body from the central passage as far as a plurality of nozzle openings.

3. The nozzle device according to claim 1, wherein the nozzle body has a noncircular cross section.

4. The nozzle device according to claim 1, wherein the nozzle body is manufactured integrally with sealing lips for sealing it off from the receptacle of the nozzle housing.

5. The nozzle device according to claim 1, wherein the nozzle body is pressed into the nozzle housing.

6. The nozzle device according to claim 1, wherein the nozzle body and/or the nozzle housing have/has a further recess and the respectively opposite component has an elastically resilient projection penetrating the further recess.

7. The nozzle device according to claim 1, wherein the further recess is designed as a groove and the projection as a bead.

8. The nozzle device according to claim 1, wherein at least one localized jet nozzle is arranged on one end side of the nozzle body and a fluidic nozzle, flat jet nozzle or fan jet nozzle is arranged on the other end side.

9. A nozzle device for cleaning a windshield or a diffusion lens of a headlamp of a vehicle comprising:
a nozzle body having at least two nozzle openings for discharging a respective jet of washing liquid, wherein the nozzle openings have different radiating characteristics and wherein at least one of the nozzle openings is designed as a localized jet nozzle,
a nozzle housing having a central passage for guiding washing liquid comprising a receptacle for a precisely fitting and nonrotatable insertion of the nozzle body,
wherein the nozzle body and the nozzle housing form a recess guided from the central passage as far as the nozzle openings,
and wherein the nozzle opening designed as a localized jet nozzle is formed partially by a wall of the nozzle body and partially by a wall of the nozzle housing.

10. The nozzle device according to claim 9, wherein a plurality of groove-type recesses extend on one side of the nozzle body from the central passage as far as a plurality of nozzle openings.

11. The nozzle device according to claim 9, wherein the nozzle body has a noncircular cross section.

12. The nozzle device according to claim 9, wherein the nozzle body is manufactured integrally with sealing lips for sealing it off from the receptacle of the nozzle housing.

13. The nozzle device according to claim 9, wherein the nozzle body is pressed into the nozzle housing.

14. The nozzle device according to claim 9, wherein the nozzle body and/or the nozzle housing have/has a further recess and the respectively opposite component has an elastically resilient projection penetrating the further recess.

15. The nozzle device according to claim 9, wherein the further recess is designed as a groove and the projection as a bead.

16. The nozzle device according to claim 9, wherein at least one localized jet nozzle is arranged on one end side of the nozzle body and a fluidic nozzle, flat jet nozzle or fan jet nozzle is arranged on the other end side.

17. A nozzle device for cleaning a windshield or a diffusion lens of a headlamp of a vehicle comprising:
a nozzle body having at least two nozzle openings for discharging a respective jet of washing liquid, wherein the nozzle openings have different radiating characteristics and wherein at least one of the nozzle openings is designed as a localized jet nozzle,
a nozzle housing having a central passage for guiding washing liquid comprising a receptacle for a precisely fitting and nonrotatable insertion of the nozzle body,
wherein the nozzle body and the nozzle housing form a recess guided from the central passage as far as the nozzle openings,
wherein the nozzle opening designed as a localized jet nozzle is formed partially by a wall of the nozzle body and partially by a wall of the nozzle housing,
wherein a plurality of groove-type recesses extend on one side of the nozzle body from the central passage as far as a plurality of nozzle openings,
wherein the nozzle body has a noncircular cross section,
wherein the nozzle body is manufactured integrally with sealing lips for sealing it off from the receptacle of the nozzle housing, and
wherein the nozzle body is pressed into the nozzle housing.

18. The nozzle device according to claim 17, wherein the nozzle body and/or the nozzle housing have/has a further recess and the respectively opposite component has an elastically resilient projection penetrating the further recess.

19. The nozzle device according to claim 17, wherein the further recess is designed as a groove and the projection as a bead.

20. The nozzle device according to claim 17, wherein at least one localized jet nozzle is arranged on one end side of the nozzle body and a fluidic nozzle, flat jet nozzle or fan jet nozzle is arranged on the other end side.
